(19) United States
(12) Patent Application Publication
(10) Pub. No.: US 2021/0337456 A1
(43) Pub. Date: Oct. 28, 2021

(54) Handling of IP 3 Tuple Component

(71) Applicant: MEDIATEK INC., Hsin-Chu (TW)

(72) Inventor: Chien-Chun Huang-Fu, Hsin-Chu (TW)

(21) Appl. No.: 17/204,523

(22) Filed: Mar. 17, 2021

Related U.S. Application Data
(60) Provisional application No. 63/013,588, filed on Apr. 22, 2020.

(51) Int. Cl. H04W 40/02; H04W 48/18; H04W 36/14; H04W 24/04

(52) U.S. Cl. CPC H04W 40/02; H04W 24/04; H04W 36/14; H04W 48/18

(57) ABSTRACT

A method for configuring Route Selection Policy (URSP) rules with IP 3 tuples as a traffic descriptor component is proposed. URSP is used by a user equipment (UE) to determine if a detected application can be associated to an established Protocol Data Unit (PDU) session, can be offloaded to non-3GPP access outside a PDU session, or can trigger the establishment of a new PDU session. URSP can be configured by the network to the UE. A new component is introduced which can include three parameters of IP 3 tuple for URSP configuration. Upon receiving the new component for IP 3 tuple component, the UE may discover certain errors and determine corresponding error handling.

### CROSS REFERENCE TO RELATED APPLICATIONS

This application claims priority under 35 U.S.C. § 119 from U.S. Provisional Application No. 63/013,588, entitled “Handling of IP 3 Tuple Component”, filed on Apr. 22, 2020, the subject matter of which is incorporated herein by reference.

### TECHNICAL FIELD

The disclosed embodiments relate generally to wireless communication, and, more particularly, to method for handling IP 3 tuple component in 5G new radio (NR) systems.

### BACKGROUND

The wireless communications network has grown exponentially over the years. A Long-Term Evolution (LTE) system offers high peak data rates, low latency, improved system capacity, and low operating cost resulting from simplified network architecture. LTE systems, also known as the 4G system, also provide seamless integration to older wireless network, such as GSM, CDMA and Universal Mobile Telecommunication System (UMTS). In LTE systems, an Evolved Universal Terrestrial Radio Access Network (E-UTRAN) includes a plurality of evolved Node-Bs (eNodeBs or eNBs) communicating with a plurality of mobile stations, referred to as User Equipments (UEs). The 3^{rd} Generation Partner Project (3GPP) network normally includes a hybrid of 2G/3G/4G systems. The Next Generation Mobile Network (NGMN) board, has decided to focus the future NGMN activities on defining the end-to-end requirements for 5G New Radio (NR) systems (5GS).

The UE policies for 5GS include UE Route Selection Policy (URSP) and Access Network Discovery and Selection Policy (ANDSP). The UE policies can be delivered from a Policy Control Function (PCF) to UE. PCF takes care of network policies to manage network behavior. PCF gets the subscription information from Unified Data Management (UDM). PCF interfaces to both Access and Mobility Function (AMF) to manage the mobility context and Session Management Function (SMF) to manage the session contexts. PCF also plays a crucial role in providing a schema for network slicing and roaming. PCF triggers the URSP which enables the UE to determine how a certain application should be handled in the context of an existing or new Protocol Data Unit (PDU) session. The UE policies can also be pre-configured in UE. The pre-configured policy should be applied by UE only when UE has not received the same type of policy from the PCF.

A PDU session defines the association between the UE and the data network that provides a PDU connectivity service. Each PDU session is identified by a PDU session ID, and includes one or more quality of service (QoS) flows and QoS rules. When the upper layers request information of the PDU session via which to send a PDU of an application, UE should evaluate the URSP rules. The UE finds the traffic descriptor in a URSP rule matching the application information, and an established PDU session matching at least one of the route selection descriptors of the URSP rule. If there is no suitable existing PDU session, the UE should establish a PDU session for one of the route selection descriptors.

In particular, for URSP rule configuration, the network can provide IP 3 tuple as a traffic descriptor component. One IP 3 tuple is composed by three traffic descriptor components: 1) IPv4 remote address type or IPv6 remote address/prefix length type; 2) protocol identifier/next header type; and 3) single remote port type or remote port range type. However, a single traffic descriptor can include different traffic descriptor components of multiple IP 3 tuples. It is impossible for UE to determine whether the different parameters are within the same or different IP 3 tuples.

A solution is sought.

### SUMMARY

A method for configuring Route Selection Policy (URSP) rules with IP 3 tuple as a traffic descriptor component is proposed. URSP is used by a user equipment (UE) to determine if a detected application can be associated to an established Protocol Data Unit (PDU) session, can be offloaded to non-3GPP access outside a PDU session, or can trigger the establishment of a new PDU session. URSP can be configured by the network to the UE. A new component is introduced which can include three parameters of IP 3 tuple for URSP configuration. Upon receiving the new component for IP 3 tuple parameters, UE may discover certain errors and determine corresponding error handling.

In one embodiment, a UE receives a non-access-stratum (NAS) message in a mobile communication network. The NAS message carries a UE Route Selection Policy (URSP) rule configuration. The UE determines an IP 3 tuple component from a traffic descriptor (TD) contained in the URSP rule. The UE performs a corresponding error handling upon the UE detecting an IP 3 tuple error of the IP 3 tuple component. The UE handles the URSP rule upon the UE detecting no IP 3 tuple error. In one example, the IP 3 tuple component comprises at least one of a destination IP address field, a destination port field, and a protocol identifier field.

Other embodiments and advantages are described in the detailed description below. This summary does not purport to define the invention. The invention is defined by the claims.

### BRIEF DESCRIPTION OF THE DRAWINGS

The accompanying drawings, where like numerals indicate like components, illustrate embodiments of the invention.

FIG. 1 illustrates an exemplary 5G network supporting handling of IP 3 tuple parameters for User Equipment (UE) Route Selection Policy (URSP) configuration in accordance with one novel aspect.

FIG. 2 illustrates simplified block diagrams of wireless devices in accordance with embodiments of the current invention.

FIG. 3 illustrates an example of the content of a URSP rule including traffic descriptor with IP 3 tuple as defined in 3GPP specification.

FIG. 4 illustrates one embodiment of a new component for IP 3 tuple configuration in accordance with one novel aspect of the present invention.

FIG. 5 illustrates another embodiment of a new component for IP 3 tuple configuration in accordance with one novel aspect of the present invention.

FIG. 6 illustrates a sequence flow between a UE and the network for URSP configuration and corresponding rule evaluation in accordance with one novel aspect of the present invention.

FIG. 7 is a flow chart of a method for IP 3 tuple configuration and error handling in accordance with one novel aspect of the present invention.

### DETAILED DESCRIPTION

Reference will now be made in detail to some embodiments of the invention, examples of which are illustrated in the accompanying drawings.

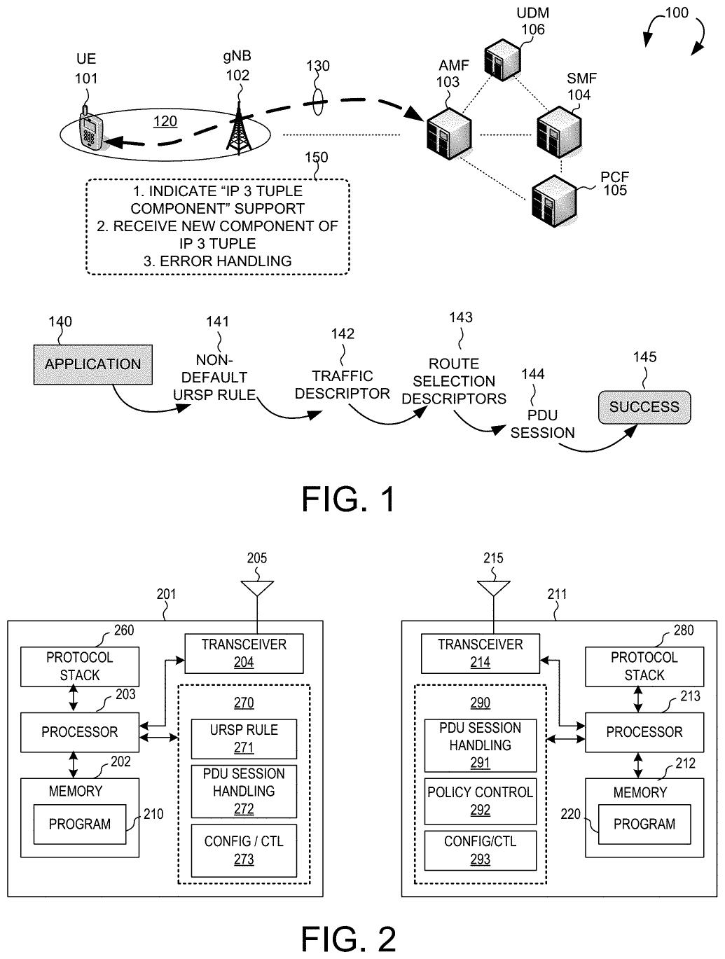

FIG. 1 illustrates an exemplary 5G network 100 supporting handling of IP 3 tuple parameters for User Equipment (UE) Route Selection Policy (URSP) configuration in accordance with one novel aspect. 5G New Radio (NR) network 100 comprises a UE 101, a base station gNB 102, an Access and Mobility Management Function (AMF) 103, a Session Management Function (SMF) 104, a Policy Control Function (PCF) 105, and a Unified Data Management (UDM) 106. In the example of FIG. 1, UE 101 and its serving base station gNB 102 belong to part of a Radio Access Network (RAN) 120. In Access Stratum (AS) layer, RAN 120 provides radio access for UE 101 via a Radio Access Technology (RAT) (e.g., 5G NR). In Non-Access Stratum (NAS) layer, AMF 103 communicates with gNB 102 and SMF 104 for access and mobility management of wireless access devices in 5G network 100. UE 101 may be equipped with a Radio Frequency (RF) transceiver or multiple RF transceivers for different application services via different RATs/CNs. UE 101 may be a smart phone, a wearable device, an Internet of Things (IoT) device, and a tablet, etc.

The UE policies for 5GS include UE Route Selection Policy (URSP) and Access Network Discovery and Selection Policy (ANDSP). The UE policies can be delivered form PCF to UE. PCF takes care of network policies to manage network behavior. PCF gets the subscription information from Unified Data Management (UDM). PCF interfaces to both AMF to manage the mobility context and SMF to manage the session contexts. PCF also plays a crucial role in providing a scheme for network slicing and roaming. PCF triggers the URSP which enables the UE to determine how a certain application should be handled in the context of an existing or new PDU session. The UE policies can also be pre-configured in UE. The pre-configured policy should be applied by UE only when UE has not received the same type of policy from the PCF.

A PDU session defines the association between the UE and the data network that provides a PDU connectivity service. Each PDU session is identified by a PDU session ID, and includes one or more quality of service (QoS) flows and QoS rules. When the upper layers request information of the PDU session via which to send a PDU of an application, UE should evaluate the URSP rules. The UE finds the traffic descriptor in a URSP rule matching the application information, and an established PDU session matching at least one of the route selection descriptors of the URSP rule. If there is no suitable existing PDU session, the UE should establish a PDU session for one of the route selection descriptors.

In the example of FIG. 1, when UE 101 starts application 140, UE upper layers trigger URSP rules evaluation. Specifically, UE 101 evaluates the URSP rules, except the default URSP rule, with a traffic descriptor matching the application information in increasing order of their precedence values. If UE 101 finds a non-default URSP rule (141) with a traffic descriptor (142) matching the application information, and an established PDU session matching at least one of the route selection descriptors (143) of the non-default URSP rule, UE 101 then provides information on the PDU session that matches the route selection descriptor of the lowest precedence value to the upper layers. Otherwise UE 101 selects a route selection descriptor with the next smallest precedence value which has not been evaluated. If no matching PDU session exists, the UE NAS layer should attempt to establish a PDU session 144 using UE local configuration. If the PDU session establishment is successful (145), the UE NAS layer should provide information of the successfully established PDU session to the upper layers.

For URSP rule configuration, the network can provide IP 3 tuple as a traffic descriptor component. One IP 3 tuple is composed by three traffic descriptor components: 1) IPv4 remote address type or IPv6 remote address/prefix length type; 2) protocol identifier/next header type; and 3) single remote port type or remote port range type. However, a single traffic descriptor can include different traffic descriptor components of multiple IP 3 tuples. It is impossible for UE 101 to determine whether the different parameters are within the same or different IP 3 tuples. In accordance with one novel aspect, a new component is introduced to include the three parameters for IP 3 tuple configuration. UE 101 may need to indicate whether it supports “IP 3 tuple component” as UE capability via NAS signaling (e.g., 5GSM procedure). Upon receiving the new component of IP 3 tuple parameters for URSP configuration, UE 101 may discover certain errors and determine corresponding error handling.

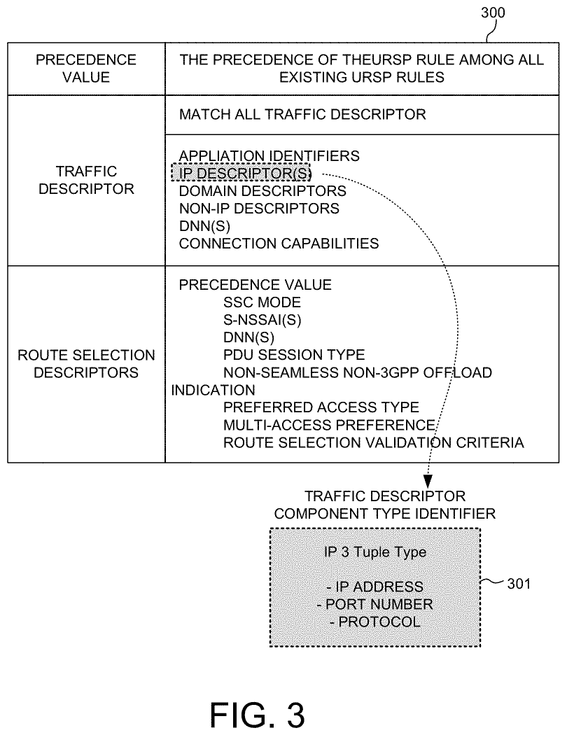

FIG. 2 illustrates simplified block diagrams of wireless devices, e.g., a UE 201 and network entity 211 in accordance with embodiments of the current invention. Network entity 211 may be a base station combined with an MME or AMF. UE 201 has memory 202, a processor 203, and Radio Frequency (RF) transceiver module 204. RF transceiver 204 is coupled with antenna 205, receives RF signals from antenna 205, converts them to baseband signals, and sends them to processor 203. RF transceiver 204 also converts received baseband signals from processor 203, converts them to RF signals, and sends out to antenna 205. Processor 203 processes the received baseband signals and invokes different functional modules and circuits to perform features in UE 201. Memory 202 stores data and program instructions 210 to be executed by the processor to control the operations of UE 201. Suitable processors include, by way of example, a special purpose processor, a Digital Signal Processor (DSP), a plurality of micro-processors, one or more micro-processor associated with a DSP core, a controller, a microcontroller, Application Specific Integrated Circuits (ASICs), File Programmable Gate Array (FPGA) circuits, and other type of Integrated Circuits (ICs), and/or state machines. A processor in associated with software may be used to implement and configure features of UE 201.

UE 201 also includes a set of functional modules and control circuits to carry out functional tasks of UE 201. Protocol stacks 260 may include application layer to manage different applications, Non-Access-Stratum (NAS) layer to communicate with an AMF entity connecting to the core network, Radio Resource Control (RRC) layer for high layer configuration and control, Packet Data Convergence Protocol/Radio Link Control (PDCP/RLC) layer, Media Access Control (MAC) layer, and Physical (PHY) layer. System modules and circuits 270 may be implemented and configured by software, firmware, hardware, and/or combination thereof. The function modules and circuits, when executed by the processors via program instructions contained in the memory, interwork with each other to allow UE 201 to perform embodiments and functional tasks and features in the network. In one example, system modules and circuits 270 may include PDU session handling circuit 271, URSP rule handling circuit 271, and config and control circuit 273 for performing URSP rules configuration and evaluation. Specifically, URSP rule handling circuit 272 updates URSP configuration, including IP3 tuple component and performs URSP rule selection accordingly. PDU session handling circuit 272 matches an existing PDU session for the application, or establishes a new PDU session. Config and control module 273 receives URSP configuration from the network, determines whether IP3 tuple error exists and performs error handling accordingly.

Similarly, network entity 211 has an antenna 215, which transmits and receives radio signals. An RF transceiver module 214, coupled with the antenna, receives RF signals from antenna 215, converts them to baseband signals and sends them to processor 213. RF transceiver 214 also converts received baseband signals from processor 213, converts them to RF signals, and sends out to antenna 215. Processor 213 processes the received baseband signals and invokes different functional modules to perform features in base station 211. Memory 212 stores program instructions and data 220 to control the operations of base station 211. In the example of FIG. 2, network entity 211 also includes protocol stack 280 and a set of control functional modules and circuit 290. PDU session handling circuit 291 handles PDU session establishment and modification procedures. Policy control module 292 that configures policy rules for UE, including IP 3 tuple component for URSP rules. Configuration and control circuit 293 provides different parameters to configure and control UE of related functionalities including mobility management and session management.

FIG. 3 illustrates an example of the content of a URSP rule including traffic descriptor with IP 3 tuple as defined in 3GPP specification. As depicted by Table 300, each URSP rule is composed of: 1) a precedence value of the URSP rule identifying the precedence of the URSP rule among all the existing URSP rules; 2) a traffic descriptor; and 3) one or more route selection descriptors. The traffic descriptor includes either 1) a match-all traffic descriptor; or 2) at least one of the following components: A) one or more application identifiers; B) one or more IP descriptors; C) one or more domain descriptors, i.e., destination FQDN(s); D) one or more non-IP descriptors, i.e., destination information of non-IP traffic; E) one or more DNNs; F) one or more connection capabilities. Each route selection descriptor includes a precedence value of the route selection descriptor and optionally, one or more of the followings: A) SSC mode; B) one or more S-NSSAIs; C) one or more DNNs; D) one PDU session type; E) a non-seamless non-3GPP offload indication; F) preferred access type; G) multi-access preference; H) Route Selection Validation Criteria (RSVC).

The IP descriptor(s) of the traffic descriptor may include, as depicted by 301 for example, IP 3 tuple including the destination IP address, the destination port number, and the protocol used above the IP. If a single traffic descriptor can include different traffic descriptor components of multiple IP 3 tuples, it would be impossible for UE to determine whether the different parameters are within the same or different IP 3 tuples. In accordance with one novel aspect, a new component is introduced to include at least one of the three parameters (IP address, port number, and protocol) for IP 3 tuple. For example, the component for IP 3 tuple may include a “IP 3 tuple ID” to identify each individual IP 3 tuple parameter, so that UE can compose the IP 3 tuple parameters based on the IP 3 tuple ID. In a preferred embodiments, the new component can be introduced to include the three parameters for IP 3 tuple for URSP configuration.

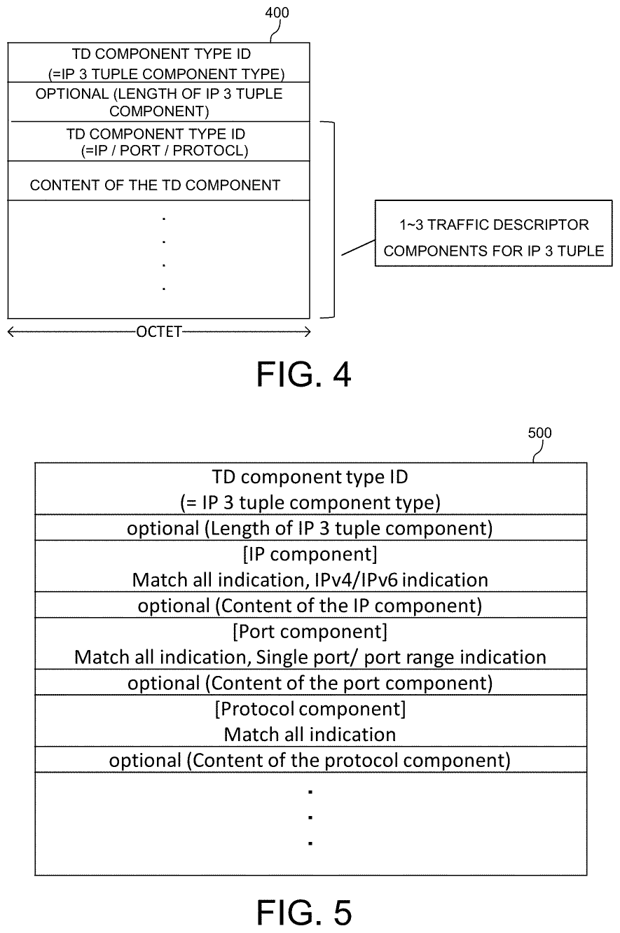

FIG. 4 illustrates one embodiment of a new component for IP 3 tuple configuration in accordance with one novel aspect of the present invention. In the embodiment of FIG. 4, the new component 400 is provided by the network for configuring a traffic descriptor during URSP configuration via NAS signaling. New component 400 comprises a TD component type ID (e.g., =IP 3 tuple component type), optionally followed by a length of the IP 3 tuple component, then followed by each individual traffic descriptor, e.g., 1-3 traffic descriptor components for IP 3 tuple. For example, a first parameter is TD component type ID=IP/PORT/PROTOCOL, followed by the next parameter is the content of the TD component.

In order to properly receive the new component carrying IP 3 tuple for URSP configuration, the UE may need to indicate whether it supports “IP3 tuple component” via NAS signaling, e.g., 5GSM procedure. In one embodiment, UE indicates the UE capability in the UE policy class mark IE included in the UE STATE INDICATION message sent to the network. UE may discover various errors and determine corresponding error handlings. The possible errors include: 1) there are more than one IP components ((IPv4 remote address type or IPv6 remote address/prefix length type), or more than one port components (Single remote port type or Remote port range; 2) There is no component in the IP 3 tuple component; and 3) Other semantic/syntactic errors. The error handlings for the above error may include: 1) UE ignores the IP 3 tuple component; 2) UE ignores the corresponding URSP rule; 3) UE rejects the NAS message which conveys the IP 3 tuple from the network, and optionally with a proper error cause (e.g., 5GSM cause, which could be a new specific cause, or existing 5GSM causes); and 4) UE accepts the NAS message which conveys the IP 3 tuple but with a proper error cause (e.g., 5GSM cause, which could be a new specific cause, or existing 5GSM causes).

FIG. 5 illustrates another embodiment of a new component for IP 3 tuple configuration in accordance with one novel aspect of the present invention. In the embodiment of FIG. 5, the new component 500 is provided by the network for configuring a traffic descriptor during URSP configuration via NAS signaling. New component 500 comprises a TD component type ID (e.g., =IP 3 tuple component type), optionally followed by a length of the IP 3 tuple component, and then followed by each individual traffic descriptor, e.g., 3 traffic descriptor components for IP 3 tuple in a predefined fixed order. For example, an IP component followed by content of the IP component, a Port component followed by the content of the Port component, and a Protocol component followed by the content of the Protocol component.

Similar to the embodiment in FIG. 4, UE may discover various errors and determine corresponding error handlings for the embodiment in FIG. 5. The possible errors include: 1) there are more than one IP components ((IPv4 remote address type or IPv6 remote address/prefix length type), or more than one port components (Single remote port type or Remote port range; 2) There is no component in the IP 3 tuple component; and 3) Other semantic/syntactic errors. The error handlings for the above error may include: 1) UE ignores the IP 3 tuple component; 2) UE ignores the corresponding URSP rule; 3) UE rejects the NAS message which conveys the IP 3 tuple from the network, and optionally with a proper error cause (e.g., 5GSM cause, which could be a new specific cause, or existing 5GSM causes); and 4) UE accepts the NAS message which conveys the IP 3 tuple but with a proper error cause (e.g., 5GSM cause, which could be a new specific cause, or existing 5GSM causes).

URSP is used by the UE to determine if a detected application can be associated to an established PDU session, can be offloaded to non-3GPP access outside a PDU session, or can trigger the establishment of a new PDU session. A URSP rule includes one traffic descriptor that specifies the matching criteria and one or more route selection descriptors. Each route selection descriptor may include one or more of the following components: SSC mode selection policy to associated the matching application with SSC mode, network slice selection policy to associate the matching application with S-NSSAI, DNN selection policy to associated the matching application with DNN, PDU session type policy to associated the matching application with a PDU session type, non-seamless offload policy to determine that the matching application should be non-seamlessly offloaded to non-3GPP access, and access type preference indicating a preferred access (3GPP or non-3GPP or multi-access) when UE needs to establish a PDU session for the matching application.

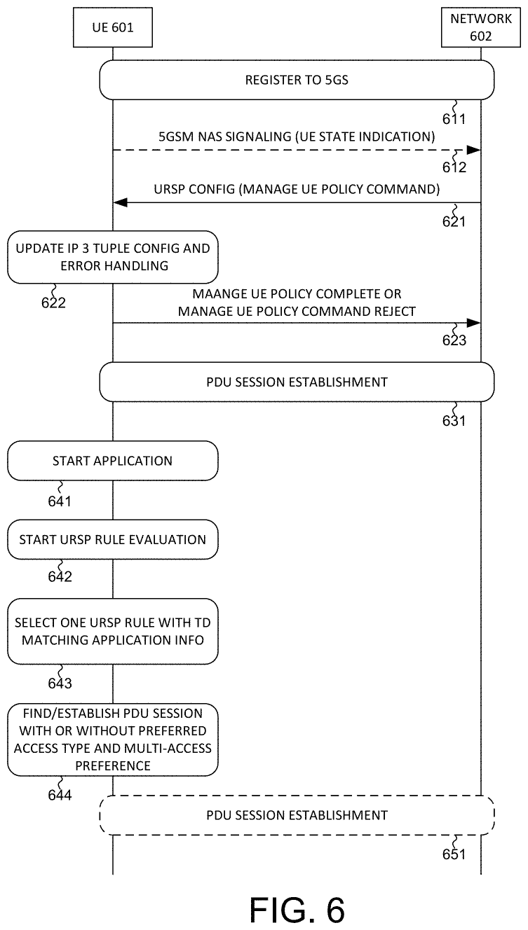

FIG. 6 illustrates a sequence flow between a UE and the network for URSP configuration and corresponding rule evaluation in accordance with one novel aspect of the present invention. In step 611, UE 601 registers to 5GS via network 602. In step 612, UE 601 may indicate whether it supports “IP 3 tuple component” via NAS signaling (e.g., UE state indication procedure). In step 621, network 602 (via PCF) provides URSP configuration or update to UE 601 (e.g., via a MANAGE UE POLICY COMMAND message). URSP may include a set of URSP rules, including one default URSP rule. In step 622, UE 601 updates its URSP rules including IP 3 tuple with error handling. For example, if UE 601 detects any semantic or syntactic error, then in step 623, UE 601 either accept or reject the URSP config by sending a MANAGE UE POLICY COMPLETE or MANAGE UE POLICY COMMAND REJECT message with proper error cause. UE may also accept the URSP config but ignore the particular URSP rule(s) with IP 3 tuple error(s). If no error is found, then UE 601 handles/updates the URSP rule. In step 631, UE 601 and network 602 establish one or more PDU sessions, each PDU session has information including Serving NSSAI, DNN, and PDU session ID.

In step 641, UE 601 starts an application. In order to determine association between the application and a PDU session or non-seamless non-3GPP offload, UE upper layers proceed with URSP rule evaluation in step 642. UE 601 tries all non-default URSP rules in an increasing order of the precedence values of the URSP rules. Specifically, in step 643, UE 601 selects one URSP rule with a traffic descriptor matching the application information, and then, in step 644, UE 601 finds an existing PDU session which matches at least one of the route selection descriptors of the selected URSP rule except or considering the preferred access type and the multi-access preference. If no matching PDU sessions exists, the UE NAS layer may then attempt to establish a new PDU session (step 651).

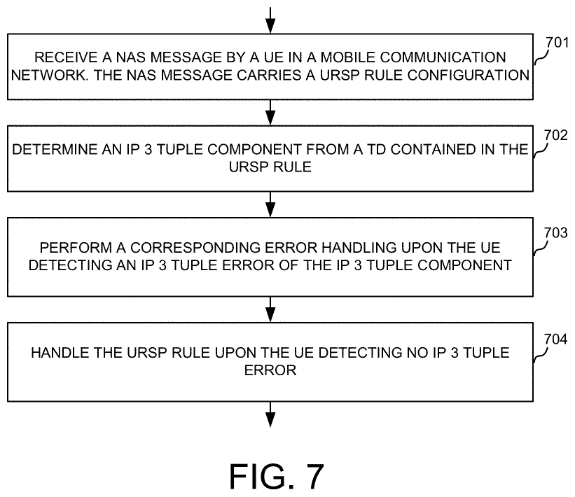

FIG. 7 is a flow chart of a method for IP 3 tuple configuration and error handling in accordance with one novel aspect of the present invention. In step 701, a UE receives a non-access-stratum (NAS) message in a mobile communication network. The NAS message carries a UE Route Selection Policy (URSP) rule configuration. In step 702, the UE determines an IP 3 tuple component from a traffic descriptor (TD) contained in the URSP rule. In step 703, the UE performs a corresponding error handling upon the UE detecting an IP 3 tuple error of the IP 3 tuple component. In step 704, the UE handles the URSP rule upon the UE detecting no IP 3 tuple error. The IP 3 tuple component comprises at least one of a destination IP address field, a destination port field, and a protocol identifier field.

Although the present invention has been described in connection with certain specific embodiments for instructional purposes, the present invention is not limited thereto. Accordingly, various modifications, adaptations, and combinations of various features of the described embodiments can be practiced without departing from the scope of the invention as set forth in the claims.

What is claimed is:

1. A method, comprising:
receiving a non-access-stratum (NAS) message by a User Equipment (UE) in a mobile communication network, wherein the NAS message carries a UE Route Selection Policy (URSP) rule configuration;
determining an IP 3 tuple component from a traffic descriptor (TD) contained in the URSP rule;
performing a corresponding error handling upon the UE detecting an IP 3 tuple error of the IP 3 tuple component; and
handling the URSP rule upon the UE detecting no IP 3 tuple error.

2. The method of claim 1, wherein the IP 3 tuple component comprises at least one of a destination IP address field, a destination port field, and a protocol identifier field.

3. The method of claim 1, wherein the TD comprises a TD component type ID indicating an IP 3 tuple component type.

4. The method of claim 3, wherein the TD further comprises one or more TD component type ID indicating an IP component type, a Port component type, or a Protocol component type followed by a content of the corresponding TD component.

5. The method of claim 1, wherein the UE detects the IP 3 tuple error when there are more than one IP address field, more than one Port field, or more than one Protocol field.

6. The method of claim 1, wherein the UE detects the IP 3 tuple error when there is no field in the IP 3 tuple component.

7. The method of claim 1, wherein the UE detects the IP 3 tuple error when there is other semantic or syntactic error in the IP 3 tuple component.

8. The method of claim 1, wherein the corresponding error handling involves the UE ignores the URSP rule.

9. The method of claim 1, wherein the corresponding error handling involves the UE rejects the NAS message or the UE transmits a 5GSM status message with a proper error cause.

10. The method of claim 1, wherein the corresponding error handling involves the UE accepts the NAS message and the UE also transmits a 5GSM status message with a proper error cause.

11. A User Equipment (UE), comprising:
a receiver that receives a non-access-stratum (NAS) message from a mobile communication network, wherein the NAS message carries a Route Selection Policy (URSP) rule configuration;
a URSP handling circuit that determines an IP 3 tuple component from a traffic descriptor (TD) contained in the URSP rule; and
a configuration and control circuit that performs a corresponding error handling upon the UE detecting an IP 3 tuple error of the IP 3 tuple component, wherein the UE handles the URSP rule upon the UE detecting no IP 3 tuple error.

12. The UE of claim 11, wherein the IP 3 tuple component comprises at least one of a destination IP address field, a destination port field, and a protocol identifier field.

13. The UE of claim 11, wherein the TD comprises a TD component type ID indicating an IP 3 tuple component type.

14. The UE of claim 13, wherein the TD further comprises one or more TD component type ID indicating an IP component type, a Port component type, or a Protocol component type followed by a content of the corresponding TD component.

15. The UE of claim 11, wherein the UE detects the IP 3 tuple error when there are more than one IP address field, more than one Port field, or more than one Protocol field.

16. The UE of claim 11, wherein the UE detects the IP 3 tuple error when there is no field in the IP 3 tuple component.

17. The UE of claim 11, wherein the UE detects the IP 3 tuple error when there is other semantic or syntactic error in the IP 3 tuple component.

18. The UE of claim 11, wherein the corresponding error handling involves the UE ignores the URSP rule.

19. The UE of claim 11, wherein the corresponding error handling involves the UE rejects the NAS message or the UE transmits a 5GSM status message with a proper error cause.

20. The UE of claim 11, wherein the corresponding error handling involves the UE accepts the NAS message and the UE also transmits a 5GSM status message with a proper error cause.
